(19) United States
(12) Patent Application Publication
(10) Pub. No.: US 2005/0284529 A1
(43) Pub. Date: Dec. 29, 2005

(54) Integrated gas control device

(76) Inventor: Toshiaki Iwabuchi, Gunma (JP)

Correspondence Address: WENDEROTH, LIND & PONACK, L.L.P., 2033 K STREET N. W., SUITE 800, WASHINGTON, DC, 20006-1021, US

(21) Appl. No.: 11/132,273

(22) Filed: May 19, 2005

(30) Foreign Application Priority Data
Jun. 25, 2004 (JP) 2004-188902

(51) Int. Cl. F16K 27/00

(52) U.S. Cl. 137/884

(57) ABSTRACT

An integrated gas control device comprising a flow path plate provided with entrance and exit holes penetrating the flow path plate in a direction of wall thickness thereof to form entrance side gangways and exit side gangways, opening groove parts opened in one or both of opposite face sides of the flow path plate and adapted to connect the entrance side and exist side gangways, seal plates for closely sealing the opening groove parts to form gas flow paths in the flow path plate, and integration units, including automatic valves, each having a flow path that are so mounted on the flow path plate as to connect the flow path to the entrance and exit holes of the flow path plate and so disposed as to allow supply of a gas including a process gas.

### BACKGROUND OF THE INVENTION

1. Field of the Invention

This invention relates to an integrated gas control device for controlling the flow rate of a process gas by means of various sorts of hardware to be integrated, such as manually operated valves, automatic operation valves and mass flow controllers, which device is used in the operation of processing semiconductors, liquid crystals and the like.

2. Description of Related Art

The flow path plate that has mounted thereon the hardware to be integrated, such as valves mentioned above, has a flow path hole formed in the interior thereof for the purpose of connecting the flow path on the exit side of a unit of hardware to the entrance side of the adjoining unit of hardware. This flow path hole is generally formed by a drilling work with a processing machine. The flow path hole is formed in a V shape or a concave shape, for example. The flow path hole has an inlet connected to the exit side of a unit of hardware and an outlet connected to the entrance side of the adjoining unit of hardware to serve to connect the flow paths of the adjacent units of hardware as a whole.

As the flow path plate mentioned above, a base plate that has mounted thereon units to be integrated, such as a filter, a regulator, a valve and a mass flow controller so as to configure a control line for the gas flowing through the integrated units via the flow path formed in the base plate has been known as disclosed in JP-A 2000-171000. The base plate in the integrated units assumes the form of a rectangular solid and, as an internal gas flow path, possesses a V-shaped flow path for connection to the ports of the adjoining integrated units.

A V-shaped flow path is continuously formed in a manifold, and a mounting device is connected to the V-shaped flow path to constitute a process line for a gas panel as disclosed in PCT-A 2001-521120, for example. The V-shaped flow path is formed by means of holes bored in the manifold.

As a flow path plate that has a flow path hole in a concave form, a gas control device connecting member wherein both a U-shaped passage formed of a bilateral pair of upwardly open passages and a communication passage communicating the lower terminal parts of the bilateral pair of upwardly open passages and an auxiliary passage for forming extended from the lower terminal of one of the bilateral pair of upwardly open passages in the direction of extension of the communication passage are formed in a plate main body as opened through the surface thereof and wherein a blocking member is inserted into the auxiliary passage for forming (as disclosed in Japanese Patent No. 3360133) may be cited.

Further, an integrated gas control device comprising a plurality of gas control devices, a basal stand provided with a groove-like depression, an intermediate flow path plate and a terminal flow path plate disposed in the depression in the basal stand, a gas control device mounting means formed of support means for supporting in a positioning state the gas control devices and connection means for connecting the gas control devices, and seal means for sealing the flow paths of the gas control devices and the gas flow paths of the flow path plates in a communicating state, has been known as disclosed in JP-A 2002-48299, for example. In the prior art integrated gas control device, the flow path plates each have a gas flow path formed therein. The gas flow path of the intermediate flow path plate, for example, has the intermediate part thereof formed in a horizontal direction along the axis of the plate. The opposite terminals of the horizontal part are bent at right angles toward the top face side and opened toward the connection means side. Inside each of the flow path plates, a flow path hole of an approximately concave shape is formed.

The flow path plate having a V-shaped flow path formed therein and opening parts of the flow path formed on the entrance and exit sides of the gas may be integrated into the so-called manifold structure by having a plurality of integration units mounted in the flow path plate. In the case of forming the flow path, the produced flow path assumes an oblique posture inclined in the direction of the thickness of the plate. For this reason, the flow path plate requires a proper thickness and inevitably occupies a large size. Since the integrated gas control device is used as for the production of a semiconductor, the flow path plate is required to use a material highly resistant to corrosion. When the flow path plate is formed of a stainless steel, for example, the large size occupied by the flow path plate is at a disadvantage in adding to the cost of material and adding to the weight as well. Further, the V-shaped flow path necessitates accuracy of finishing because it is manufactured by drilling holes from the entrance and exit sides of the plate with a perforating device so as to communicate in an intersecting manner with each other and further because the holes, even after establishing the mutual communication, are required to have the neighborhood of the intersection subjected to a finishing work. The bent region of the interior of this flow path has the possibility of inducing stagnation of a process gas or purge gas.

In the case of forming a concave flow path in a flow path plate, it is made possible to decrease the thickness of the flow path plate and the whole size of the plate because of the absence of an inclination from the flow path, suppress the rise of the cost of material, preclude the increase of the weight, form the flow path easily because of the simplicity of work, and prevent retention of the residual gas and exalt the flow of the gas as compared with the V-shaped flow path. The formation of this flow path, however, entails a new problem.

The flow path plate having a concave flow path has one concave flow path formed per plate. In configuring a gas flow path, therefore, it is necessary that as many flow path plates be concatenated as integrating devices to be installed. For the purpose of mounting short flow path plates in a linearly arrayed state, it becomes necessary to provide the basal part with a guide groove or a region for a mounting rail or use a fixing member for fixing the flow path plates. Since the configuration of a gas flow path by the use of a flow path plate having a concave flow path, therefore, gives rise to an anxiety about the possibility of complicating the structure and increasing the number of component parts, the desirability of simplifying the structure during the formation of a flow path and decreasing the number of component parts has been finding recognition. Further, since the configuration tends to result in giving an increased size to the produced flow path plate, the desirability of compacting the whole integrated gas control device has been finding approval.

Then, in the work of producing a concave flow path deliberately in the individual flow path plates, it is necessary that first a flow path in the horizontal direction be so formed as to bore a flow path plate from one end face to the other end face, then the inlet and exit side flow paths connecting with integration units be bored inwardly from the face side orthogonal to the horizontal flow path so as to intersect these flow paths, and, after the boring work, the unnecessary bored parts of the individual flow path plates other than the flow paths be closed by welding Thus, the desirability of simplifying the operations involved in this work has been finding recognition. Also in the work of assembly, the individual flow path plates must be incorporated in the flow paths of the integration unit. The desirability of facilitating the operations involved in this work of assembly has been likewise finding approval.

This invention has been developed in the light of the problems of the prior art mentioned above. It is aimed at solving the various problems encountered by the conventional integrated gas control device and consequently providing an integrated gas control device which allows the work of forming a gas flow path for maintaining smooth flow of a gas, such as a process gas, to be carried out simply and infallibly while permitting a cut of the time spent for the work, simplifies the structure of the device in a wholly compact form, ensures smooth supply of the gas, and precludes the phenomenon of stagnation of the gas.

### SUMMARY OF THE INVENTION

To attain the above object, the present invention provides an integrated gas control device comprising a flow path plate provided with entrance and exit holes penetrating the flow path plate in a direction of wall thickness thereof to form entrance side gangways and exit side gangways, opening groove parts opened in one or both of opposite face sides of the flow path plate and adapted to connect the entrance side and exist side gangways, seal plates for closely sealing the opening groove parts to form gas flow paths in the flow path plate, and integration units, including automatic valves, each having a flow path that are so mounted on the flow path plate as to connect the flow path to the entrance and exit holes of the flow path plate and so disposed as to allow supply of a gas including a process gas.

In the integrated gas control device, the seal plates each have a size proper for completely covering the opening groove parts.

In the first mentioned integrated gas control device, the seal plates cover at least a substantially whole surface of the flow path plate on a side of the opening groove parts, and the opening groove parts are closely sealed through fixation of the seal plates thereon.

In the third mentioned integrated gas control device, the seal plates are reinforced each with a reinforcing plate superposed thereon.

In the first mentioned integrated gas control device, the seal plates closely seal and fix the flow path plate by means of welding that is electron beam welding, laser welding, TIG welding or brazing.

In the second mentioned integrated gas control device, the seal plates closely seal and fix the flow path plate by means of welding that is electron beam welding, laser welding, TIG welding or brazing.

In the first mentioned integrated gas control device, the seal plates closely seal and fix the flow path plate by means of welding that is electron beam welding, laser welding or spot welding.

In the third mentioned integrated gas control device, the seal plates closely seal and fix the flow path plate by means of welding that is electron beam welding, laser welding or spot welding.

In the fourth mentioned integrated gas control device, the seal plates closely seal and fix the flow path plate by means of welding that is electron beam welding, laser welding or spot welding.

In the first mentioned integrated gas control device, the gas flow paths comprise first flow paths directed toward the gangways and the opening groove parts and second flow paths assuming directions different from the first flow paths.

The first mentioned integrated gas control device further comprises circular mounting parts formed on a side of the flow path plate for mounting the integration units thereon, retaining tubular members formed substantially in a cylindrical shape and inserted into the circular mounting parts, and wherein the integration units are fixed onto the flow path plate through the retaining tubular members.

The eleventh mentioned integrated gas control device further comprises mounting parts insertable in the flow path plate and formed in lower parts of the retaining tubular members, cylindrical mounting tubes disposed on an upper face side of the mounting parts, helically attachable union nuts provided on the mounting tubes, and center lock means clamping the union nuts on the retaining tubular members and fastening the integration units to the flow path plate while the retaining tubular members are kept inserted in the flow path plate.

The integrated gas control device just mentioned above further comprises one set of flange parts formed protrudingly on a side of the flow path plate for mounting the integration units thereon and idly insertable hook members formed on opposite sides of the mounting parts as slid in a direction of the flow paths toward the flange parts, the hook members being idly inserted into the flange parts so as to insert the retaining tubular members into the flow path plate.

In the third mentioned integrated gas control device, the gas flow paths of the flow path plate are formed as disposed in a multiplicity of rows and further comprising purging flow paths formed in a collected pattern for expelling gas from interiors of the individual gas flow paths.

The third mentioned integrated gas control further comprises deep holes formed in the flow path plate, inserting grooves identical in shape with the deep holes formed on a lower face side of a body of each of the integration units, and gaskets retained between the flow path plate and the body.

The first mentioned integrated gas control device further comprises a purging flow path formed in the flow path plate to intersect the flow paths for purging the gas in the flow paths and a bypass flow path formed halfway in lengths of gas flow paths for detouring the purging flow path.

According to the invention, in the construction of a flow path plate to be used in an integrated gas system for performing the supply and exhaustion of a gas, the work of forming a flow path can be performed simply with high accuracy while greatly curtailing the working time than ever. The invention, therefore, can provide an integrated gas control device permitting a generous cut of cost because the flow path plate can be formed to conform the construction in one series or a plurality of series and comply with a flow path of any conceivable construction as well by decreasing the wall thickness thereof to the fullest possible extent, thereby promoting the cut of weight, compacting the whole volume of the construction, and improving the footprint. Further, since the flow path can be easily altered in compliance with an increase or a decrease of the number of integrated units, the alteration of the main body of the controlling device which is necessitated in consequence of the alteration of the construction of the flow path can be accomplished in a short time with the cost cut to the fullest possible extent.

Moreover, since the flow path plate has holes bored therethrough from the front to the rear side, a bypass flow path can be easily formed by utilization of the side that is not the side for mounting the integrated unit column.

The invention concerns an integrated gas control device that allows a gas flow path to be formed while maintaining a high sealing property and enables the flow path to be formed quickly and simply. The invention can greatly shorten the operating time because all the portions on either the front surface or the rear surface can be shielded by one round of operation. The invention concerns an integrated gas control device that infallibly prevents leakage from a flow path by exalting the strength of the whole device. When the parts for shielding the through path and the open groove part are sealed by covering them with one member, the polishing work can be facilitated because the polishing of the gas contacting side of this member can be completed in a single round of work.

The inventions concern an integrated gas control device which can form a flow path easily by an infallible and speedy work, work fixed parts to a high quality level, and impart an exalted strength to the fixed parts.

The invention concerns an integrated gas control device which permits a purging valve to be mounted thereon and, in that case, permits a purging flow path having the purging valve mounted thereon to be formed in a direction different from an internal flow path, and enables formation of an effective flow path by causing the gas flow path and the purging flow path to be formed on different surfaces of a flow path plate.

According to the invention, an integration unit can be easily positioned relative to a flow path plate and mounted at a correct position.

According to the invention, an integration unit is retained in an infallibly positioned state on a flow path plate and is enabled to maintain a closely sealed state without being possibly clamped unevenly because of the inability thereof to incline from this joined state. This invention concerns an integrated gas control device which enables the integration unit to be clamped by a simple operation as perfectly balanced without generating a couple of force and, as a result, acquires exalted sealability. The device further permits miniaturization because of its capability of suppressing the volume of the mounting part.

The invention covered concerns an integrated gas control device that, during the attachment of the individual integration units, enables each integration unit to be easily positioned and simply inserted and further enables the integration unit to be infallibly and simply joined in a connected state to a flow path and consequently imparts high accuracy to the formed flow path.

The invention concerns an integrated gas control device which, even in the case of having gas flow paths disposed in a multiplicity of series relative to one flow path plate, enables the flow paths to be efficiently disposed inside the flow path plate by forming purging valves as collected in order and consequently enables a purge air to be discharged collectively through one flow path. Further, this device is capable of being so manufactured that the gas flow paths laid in a multiplicity of series and one collective group of purging flow paths may be covered altogether at once by covering the entire opening groove part side of the flow path plate with a seal plate.

The invention covered concerns an integrated gas control device that is adapted to perform infallibly the sealing of the integration units and the flow path plate and prevent leakage of the gas.

### BRIEF DESCRIPTION OF THE DRAWINGS

FIG. 1 is a perspective view illustrating a flow path plate in an integrated gas control device according to this invention.

FIG. 2 is a partially cutaway perspective view of the flow path plate shown in FIG. 1.

FIG. 3 is a perspective view illustrating a mounting condition of seal plates.

FIG. 4 is a perspective view illustrating a first embodiment of the integrated gas control device according to this invention.

FIG. 5 is a perspective view illustrating the integrated gas control device viewed from a different angle.

FIG. 6A to FIG. 6D are partially magnified cross sections illustrating a process for the production of the flow path plate.

FIG. 7 is a partially cutaway magnified front view illustrating a second embodiment of the integrated gas control device contemplated by this invention.

FIG. 8 is a partially magnified cross section of the embodiment of FIG. 7.

FIG. 9 is a cross section taken through FIG. 8 along line IX-IX.

FIG. 10 is a cross-sectional side view of the flow path plate shown in FIG. 8.

FIG. 11 is a partially cutaway side view of FIG. 7.

FIG. 12 is a perspective view illustrating an integration unit in a fixed state.

FIG. 13 is a perspective view illustrating an internal flow path of a flow path plate.

FIG. 14 is a plan view illustrating the flow path plate of FIG. 13 in a state having retaining cylinders inserted therein.

FIG. 15 is a partially cutaway magnified front view illustrating the third embodiment of the integrated gas control device contemplated by this invention.

FIG. 16 is a partially cutaway magnified front view illustrating the fourth embodiment of the integrated gas control device contemplated by this invention.

FIG. 17 is a partially cutaway perspective view illustrating a flow path plate in the configuration of FIG. 16.

FIG. 18A is a partially cutaway front view illustrating the integrated gas control device in a state having a flow path plate inserted therein, FIG. 18B a cross section depicting flow paths formed inside the flow path plate, and FIG. 18C a plan view of the flow path plate.

FIG. 19 is a partially cutaway front view illustrating another example of forming a bypass flow path of a flow path plate.

### DETAILED DESCRIPTION OF THE INVENTION

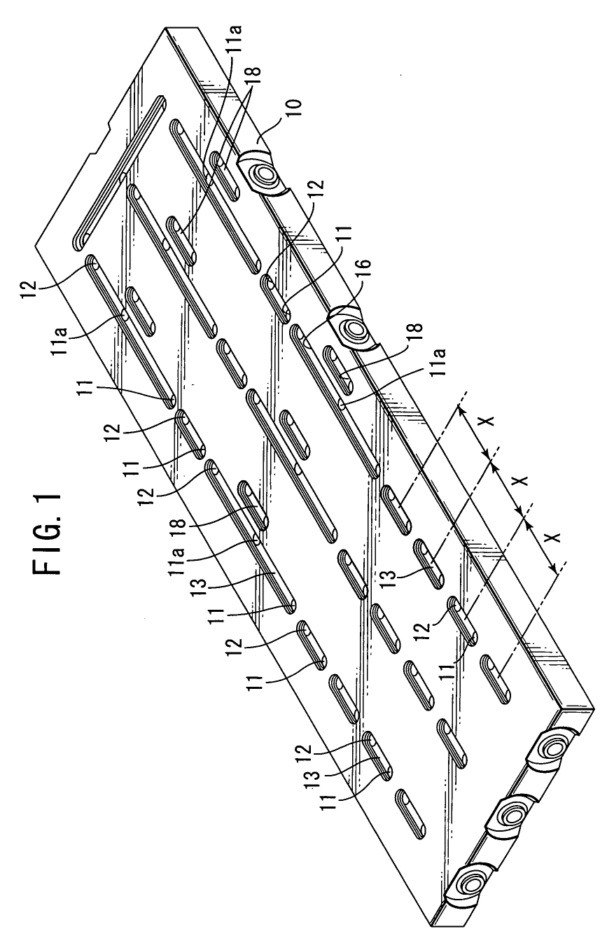

The embodiments and the operation of the integrated gas control device contemplated by this invention will be described below with reference to the accompanying drawings. In FIG. 1 through FIG. 6, the integrated gas control device contemplated by this invention is illustrated. In a main body 1 of the integrated gas control device, gas-controlling lines 2 for controlling the supply of a gas, such as a process gas, are disposed in a single row or a plurality of rows. The individual gas-controlling lines 2 are formed by connecting individual integration units 100 of valves, such as automatic valves, disposed in a longitudinal pattern to gas flow paths 16 disposed inside a flow path plate 10. By having the integration units 100 mounted on the flow path plate, the flow paths are formed.

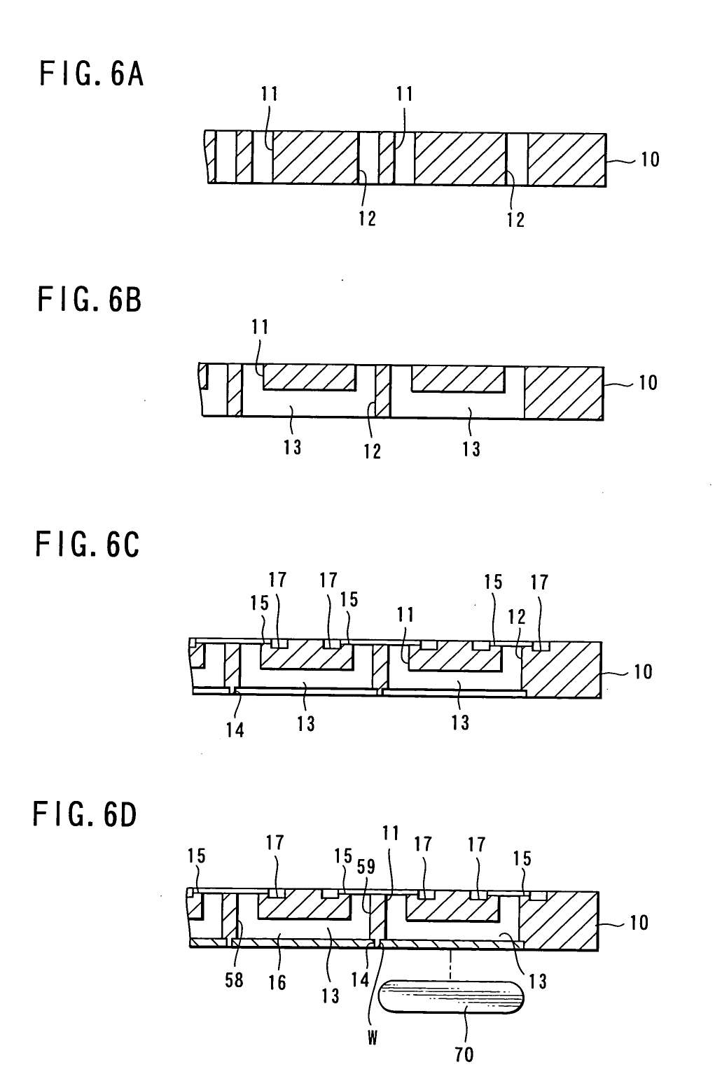

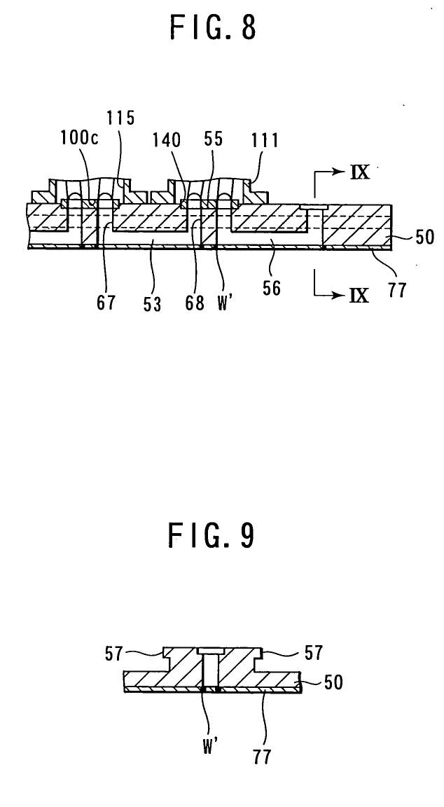

In the flow path plate 10, the entrance and exit holes for connecting the flow paths of the adjacent integration units 100 are made to penetrate this flow path plate 10 in the direction of wall thickness as illustrated in the diagram to give rise to entrance side gangways 11 and exit side gangways 12 in the flow path plate 10. This work is implemented by the use of a control-processing machine provided with a drill not shown in the diagram. During the course of this work, first the gangways 11 and 12 are formed in the direction of wall thickness through the flow path plate 10 as illustrated in FIG. 6A. Subsequently, opening groove parts 13 for connecting the gangways 11 and 12 are formed on one face side of the flow path plate 10, namely on the rear face side in the present embodiment as illustrated in FIG. 6B and, further, radially diverged groove parts 14 of the shape of a such an oblong hole as diverges from the opening groove parts 13 and deep holes 15 for the insertion of gaskets 140 (FIG. 8) formed of stainless steel and adapted to intervene during the connection of the integration units 100 on the entrance and exit sides of the gangways 11 and 12 are formed as illustrated in FIG. 6C. The gaskets 140 to be used herein may be in either of the seal forms, namely the seal form called the C seal having a cross section approximately in the shape of the letter C such that the two projections disposed on the upper and lower side thereof may manifest a sealing force on exposure to a compressing force and the seal form called the W seal having a cross section in the shape of the inverted letter U such that the upper side and the radially diverting face side thereof may form necessary seal on exposure to a compressing force. The gaskets formed in some other proper profile may be used. Thereafter, a gas flow path 16 is formed in the flow path plate 10 by closely sealing the opening groove parts 13 with a seal plate 70 as illustrated in FIG. 6D. Thus, the flow path plate 10 is formed in the interior thereof with the gas flow path 16. Incidentally, purging holes 11a are disposed at proper positions between the gangways 11 and 12 as illustrated in FIG. 1.

The seal plate 70 is formed in a shape and a size such that it may attain insertion into the radially diverged groove parts 14 and is also formed in a thickness approximately equaling the depth of the radially diverged groove parts 14. Thus, the seal plate 70 has a large size that is capable of completely covering the opening groove parts 13 formed in the flow path plate 10. By fitting this seal plate 70 into the radially diverged groove parts 14 and fixing it therein, the gangways 11 and 12 (and the purging hole 11a as well) and the opening groove parts 13 are closely sealed. The seal plate 70 is only required to seal closely and fix the flow path plate 10 at the welding point W with welding means, such as electron beam welding, laser welding, TIG welding or brazing. The welding may be attained by some other proper welding means. Otherwise, the fixing may be attained with a fixing means other than the welding means.

The gangways 11 and 12 (and the purging hole 11a as well), the opening groove parts 13 and the radially diverged groove parts 14 are worked at once by continuously processing one platy material by the use of a computer-controlled processing machine. To be specific, one control-processing machine is operated to form the gangways 11 and 12, the opening groove parts 13, etc. and shield the opening groove parts 13. Consequently, the work is accomplished in a short span of time without entailing appreciable trouble. The present embodiment contemplates opening the opening groove parts 13 of the flow path plate 10 on the rear face side which is one of the face sides, shielding the opening groove parts 13, and opening the gangways 11 and 12 intended for fitting the integration units 100 on the front face side. It is otherwise permissible to seal the opening groove parts 13 opened in advance on the front face side and open the gangways 11 and 12 for fitting the integration units 100 on the rear face side. It is also permissible to open the opening groove parts on both the front and rear face sides of the flow path plate 10 and then seal closely the opening groove parts with the seal plate. The distance X from one set of gangways 11 and 12 to another set of gangways 11 and 12 is the same pitch as illustrated in FIG. 1. By having the integration units 100 mounted with an equal interval as mentioned above, the integration units 100 are enabled to be connected to any set of gangways 11 and 12 when the surface areas for mounting the individual integration units 100 in the direction of mounting are equalized and they can be effectively mounted without requiring formation of a new flow path plate even when the mounting positions and the mounting sequence of the integration units 100 are varied in consequence of an alteration of flow paths of the integrated gas control device.

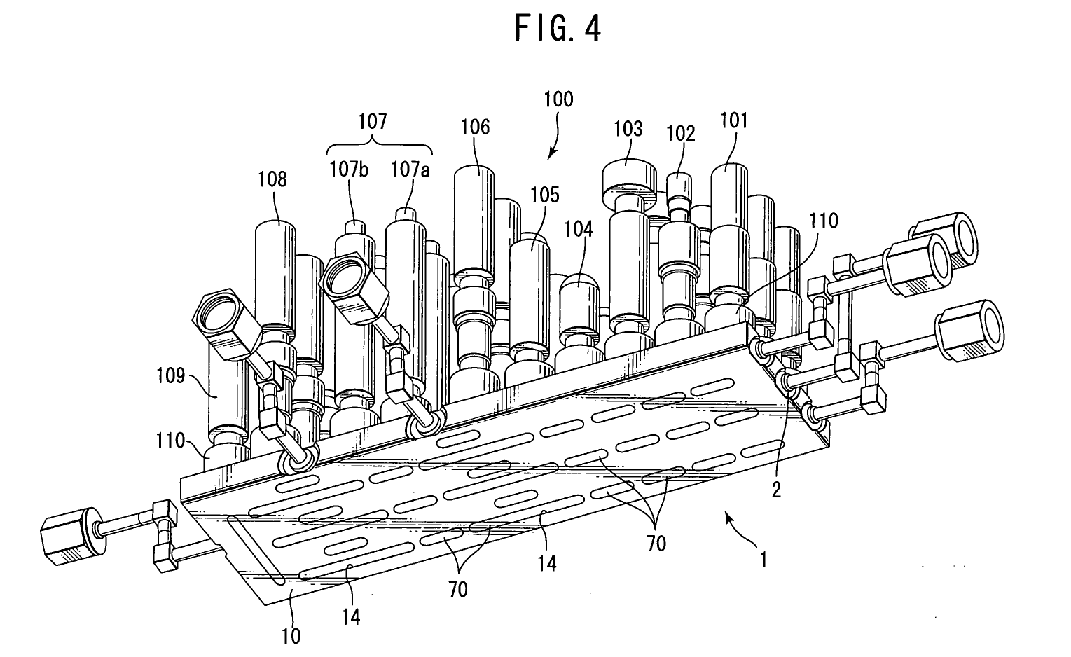

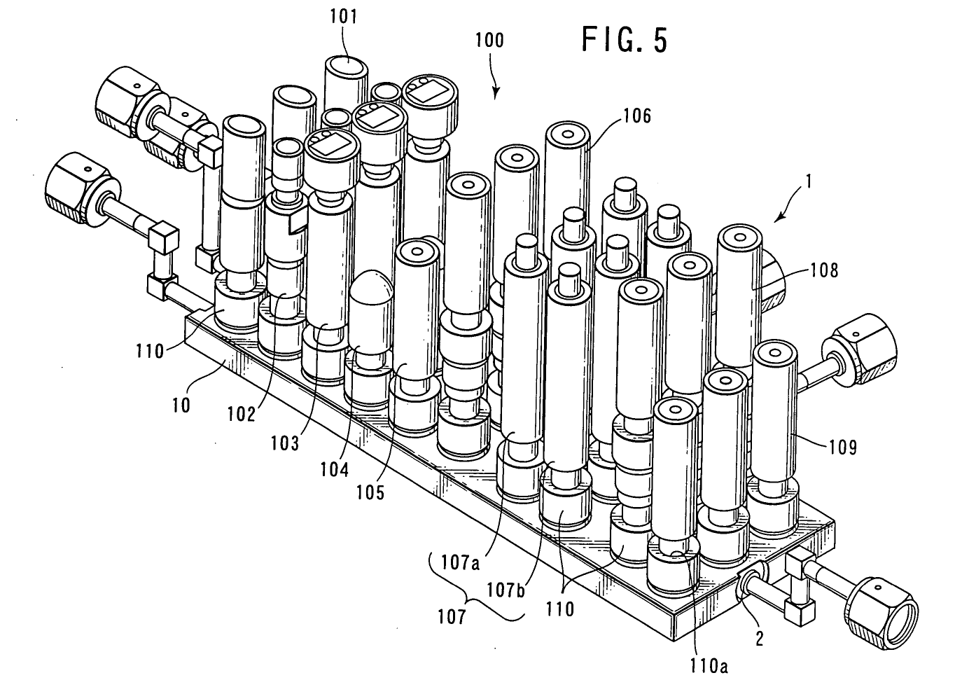

Purging flow paths 18 appearing in FIG. 1 are formed respectively at the positions for mounting purging valves 106 and 108 used for purging a gas as illustrated in FIGS. 4 and 5. These purging flow paths 18 are so disposed as to enable the gas passing the interiors of the gas flow paths to be expelled through the purging flow paths 18 via the purging holes 11a. During the formation of the purging flow paths 18, similarly to the formation of the gas flow paths 16, it suffices to form the opening groove parts after the provision of the gangways and give rise to necessary gas flow paths and subsequently seal closely the opening groove parts with the seal plate by welding means, such as electron beam welding, for example. The purging flow paths 18 can be easily formed even when the gas flow paths 16 are formed as disposed in a multiplicity of rows. Otherwise, they may be formed collectively as one purging flow path.

Since the gas flow paths 16 are formed in a concave shape, they are incapable of stagnating a residual gas or emitting particles. Further, since the flow path plate can be formed in a small wall thickness, it promises compaction of dimensions and diminution of weight instead of occupying a large volume or adding to the number of parts for forming flow paths. Moreover, during the course of the processing work, this processing work can be facilitated and the processing accuracy can be exalted because the gangways and other similar paths are continuously formed and welded by computer-controlling the operation of the control-processing machine. The main body 1 of the integrated gas control device can be miniaturized on account of the procedure which comprises forming the gas flow paths 16 in one flow path plate 10 of a small wall thickness and connect the individual integration units 100 to the gas flow paths 16.

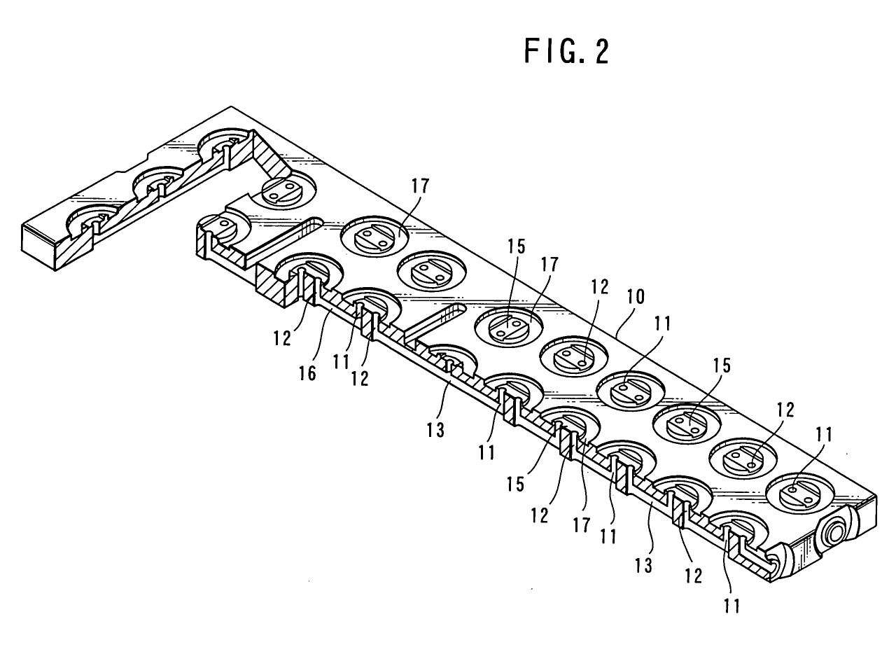

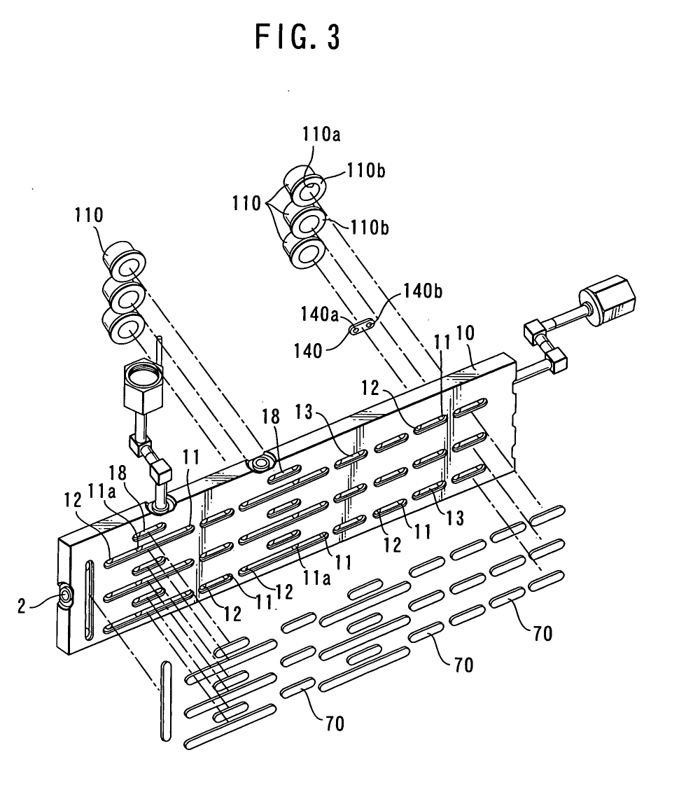

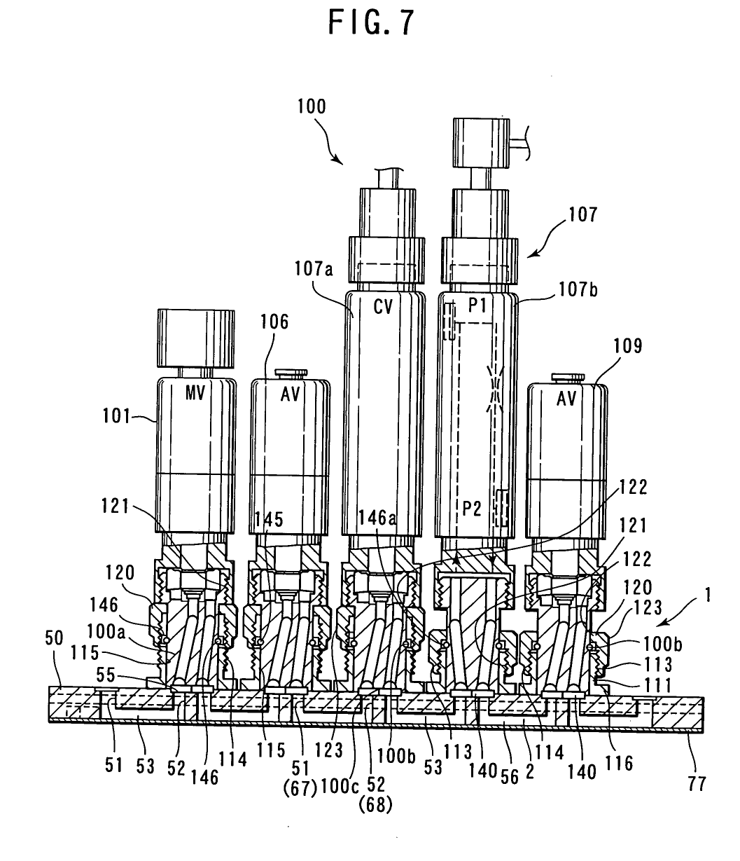

Mounting parts 17 are formed on the side for mounting the integration unit 100 in the flow path plate 10 by cutting circles with the control-processing machine as illustrated in FIG. 2, and retaining tubular members 110 are formed in the mounting parts 17 in an insertable form as illustrated in FIG. 3. The retaining tubular members 110 are formed approximately in a cylindrical shape and are provided on the inner side thereof with the inserting hole 110a allowing insertion of a body 100a (FIG. 7) of the integration unit 100 and on the outer side thereof with a flange part 110b which can be inserted into the mounting part 17. The retaining tubular members 110 can be welded as kept inserted in the mounting parts 17 with welding means, such as electron beam welding, or mounted therein and fixed, or fixed thereto with some other proper means. The mounting of the integration unit 100 is infallibly accomplished by causing a first gas flow path and a second gas flow path formed, though not shown in the diagram, inside the individual body 100a to be fixed to the flow path plate 10 through the retaining tubular member 110 as laid astride an exit flow path 59 on the gangway 12 side of the exit side and an entrance flow path 58 on the gangway 11 side on the entrance side which lie adjacently in the flow path plate 10 while keeping the gasket 140 nipped between the flatly formed lower face side of the body 100a and the deep hole 15 of the flow path plate 10. The integration unit 100 is infallibly fixed by implementing the positioning with the retaining tubular member 110 even when the direction of the gangway and the opening groove part and the direction of the gas flow path differ by 90 degrees as in the flow paths of the purging valve. The gasket 140 has holes 140a and 140b formed therein for allowing passage of a gas. The first gas flow path and the second gas flow path are made to communicate with the entrance flow path 58 and the exit flow path 59 through these holes 140a and 140b and they are enabled as held in this state to seal the integration unit 100 and the flow path plate 10. Since one continuous gas-controlling line 2 can be completed without using any fitting bolt by fixing the individual integration units 100 by the use of the retaining tubular members 110, the integration units 100 while being mounted enjoy economization of the space in the direction of the mounting faces and shun dimensional enlargement due to superposition in the mounting direction. Further, since a plurality of mounting parts 17 can be formed at once with the control-processing machine, the sites for mounting the integration units 100 disposed in a multiplicity of rows can be easily provided.

One example of the individual integration unit 100 in the present embodiment is composed of an entrance side manually operated valve 101 for switching the flow paths, a filter unit 102 for removing the impurity entrained by the gas, a regulator 103 for adjusting the pressure of the gas, a pressure transducer 104 for sensing the pressure of the flowing gas, an automatic valve 105 for switching the flow path, a purging valve 106 used for the supply of the purging gas, a mass flow controller unit 107 for controlling the flow volume of the gas, a purging valve 108 and an exit side automatic valve 109 for switching the flow path for the gas as illustrated in FIG. 4 and FIG. 5.

The mass flow controller unit 107 is divided into two parts, i.e. a control valve part 107a and a sensor bypass part 107b. The control valve part 107a is provided in the interior thereof with an automatic valve, and the sensor bypass part 107b is provided in the interior thereof with a sensor, a bypass and a sensor amplifier, though not shown in the diagram. Owing to the configuration of dividing the mass flow controller unit as described above, the individual units of the control valve part 107a and the sensor bypass part 107b are enabled to be so formed as to fit the surface area and the dimensions in the direction of mounting the other integration unit 100. Consequently, the mass flow controller unit 107 while being mounted can be handled similarly to the other integration unit 100 and can be mounted at an expected mounting position without being restricted by the mounting dimensions and the layout as generally experienced by a large mass flow controller. It is naturally permissible to have the mass flow controller mounted wholly, namely without being divided into the valve part and the sensor, bypass and sensor amplifier. In this case, however, it is necessary that the gas flow paths be formed in a structure conforming to the shape of the mass flow controller and the positions of the first and second gas flow paths. Incidentally, a basal plate part not shown in the diagram may be provided separately of the sensor bypass part 107b and this basal plate part may be mounted on the sensor bypass part 107b and used for controlling the sensor and other parts.

Of course, the integration unit 100 may be mounted as combined in some other manner than is mentioned above with the main body 1 of the integrated gas control device. This combination may be selected arbitrarily to suit the kind and the use of the gas. For example, the manually operated valve 101 may be provided with a manually operating mechanism resorting to a toggle mechanism incapable of generating unwanted resilience of a spring. When the surface area for mounting in the mounting direction is fixed as described above, even the other integration unit differing in configuration may be mounted so long as the surface area for mounting is the same. Incidentally, in the preceding embodiment, it is preferred that the flow path plate and the seal plate are formed of stainless steel as a material. Nevertheless, they may be formed of some other metallic material or even a material, such as resin, possessing resistance to corrosion.

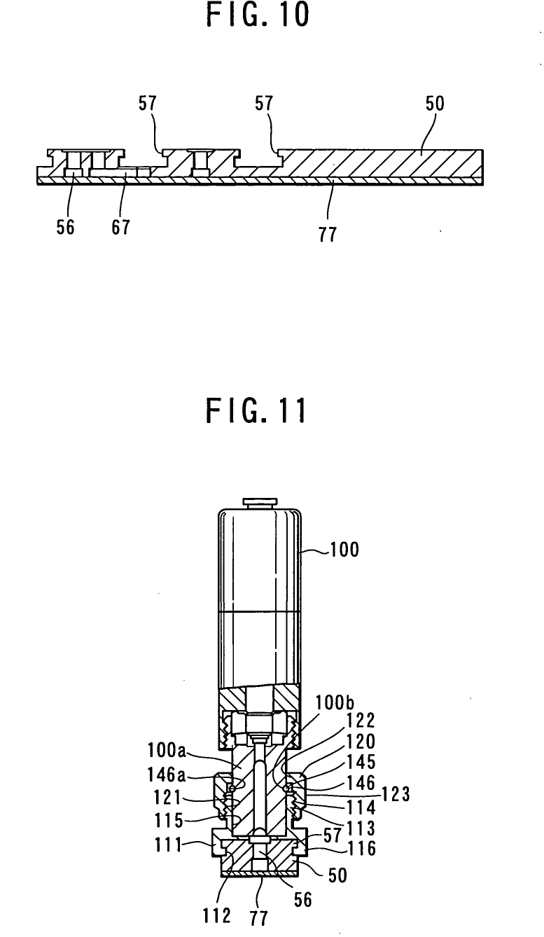

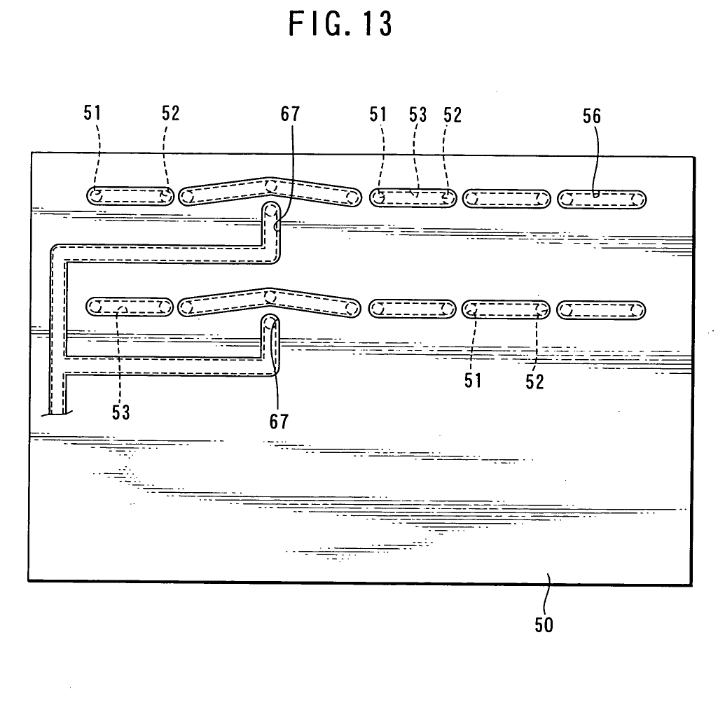

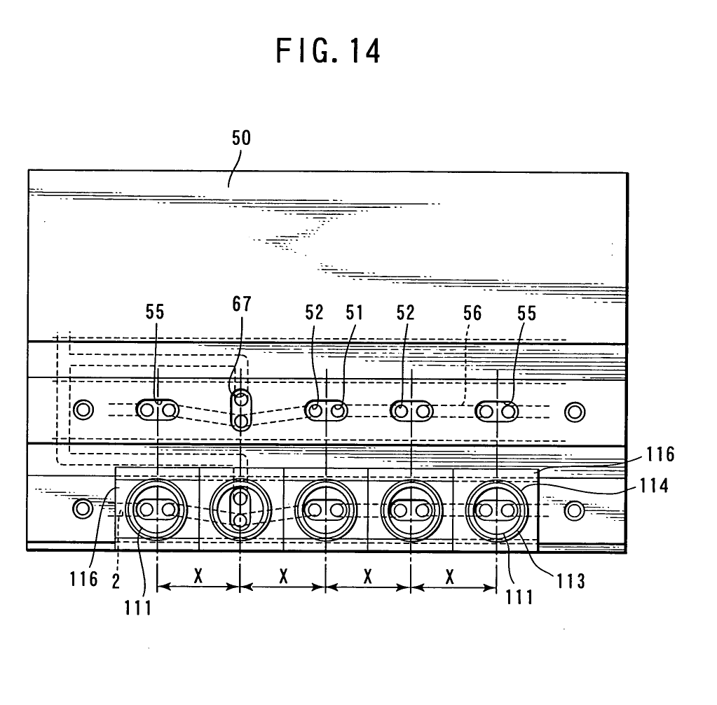

Illustrated in FIG. 7 to FIG. 14 is a second embodiment of the integrated gas control device contemplated by this invention. In the following embodiments, like parts used in the first embodiment will be denoted by like reference numerals and will be omitted from the following description. In the present embodiment, a flow path plate 50 is furnished in the interior thereof with a gas flow path 56, and a seal plate 77 is for covering at least substantially the whole surface on the side of an opening groove part 53 formed in the flow path plate 50. Thus, by fixing the seal plate 77, gangways 51 and 52 are enabled to seal an opening groove part 53 closely. This fixing is implemented by welding means, such as electronic beam welding, laser welding or spot welding at the welding position W appearing in FIG. 9 and is enabled to seal the interior of the flow path plate 50 closely.

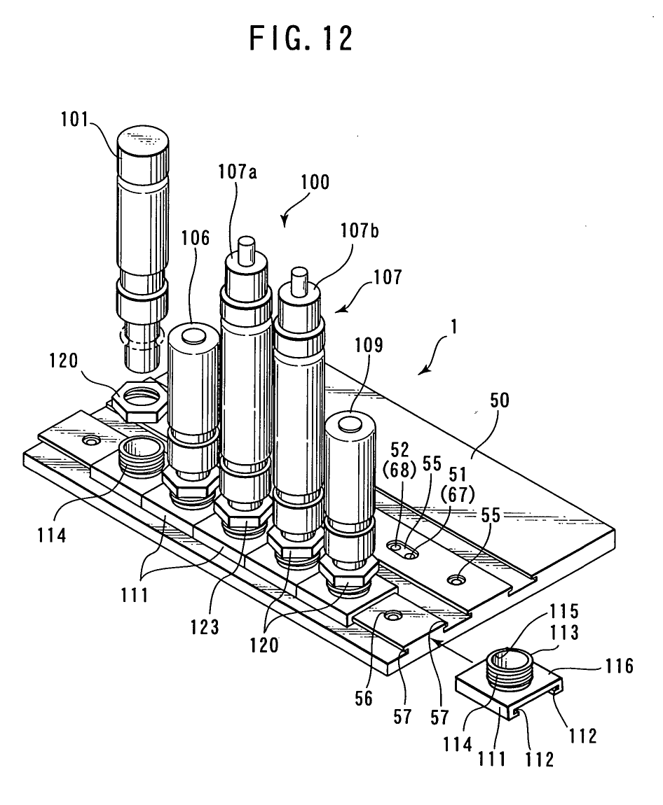

The flow path plate 50 has flange parts 57 formed as illustrated in FIG. 12 by the use of a control-processing machine. The flange parts 57 are formed as projected on the sides for mounting the integration unit 100 and adapted to permit insertion of retaining tubular member 111. When the flange parts 57 are formed as a set of two bilateral pieces, they are enabled to form a mounting portion of a T-shaped cross section. By fitting a retaining tubular member 111 into the T-shaped mounting portion and attaching the integration unit 100 to the retaining tubular member 111, one continuous gas-controlling line 2 is completed. When the flange parts 57 are disposed in parallel on the flow path plate 50, they can form mounting portions for integration units 100 disposed in a multiplicity of rows.

The individual integration unit 100 is composed of the manually operated valve 101 for switching the flow path, the purging valve 106 connected to the purging gas flow path, the mass flow controller unit 107 consisting of a control valve part 107a and a sensor bypass part 107b, and the exit side automatic valve for switching the gas flow path. The integration unit 100 is connected and fixed to the flow path plate 50 by the use of the retaining tubular member 111 and a union nut 120. The retaining tubular member 111 is provided in the lower part thereof with a mounting part 116 having a cross section of substantially the shape of the letter C and also provided on the opposite sides of the mounting part 116 with hook parts 112 capable of being slid in the direction of flow path toward the flange parts 57 of the flow path plate 50 and idly inserted therein. The mounting part 116 has a cylindrical mounting tube 113 formed on the upper face side thereof and this mounting tube 113 has a male screw part 114 formed on the outer peripheral side thereof. The mounting tube 113 has formed on the outer peripheral side thereof an insertion hole 115 that permits the body 100a to be inserted as tightly fitted.

The mounting of the retaining tubular member 111 on the flow path plate 50 is implemented by causing the hook parts 112 to be fitted to the flange parts 57 of the flow path plate 50 as slid in the lateral direction thereto. By fixing the retaining tubular member 111 to the flow path plate 50 in the manner described above, it is made possible to fix the integration unit 100 to the retaining tubular member 111. The retaining tubular member can be fixed to the flow path plate by the use of any of the other various kinds of fixing means.

A union nut 120 is formed substantially in a tubular shape and is provided on the inner peripheral side thereof with a female screw part 121 helically joinable to the male screw part 114 of the retaining tubular member 111. An annular radially converged part 122 of the shape of a flange is formed in the upper part of the female screw part 121. The union nut 120 has further formed on the outer peripheral face side with a nut part 123 capable of being tightened with a tool. This union nut 120 is prevented from falling off the integration unit 100 by inserting a metallic C ring 145 into a radially converged annularly concave part 100b attached pivotally rotatably to the outer periphery of the body 100a and formed in the body 100a and subsequently inserting a seal member 146 into a concave part 146a formed on the inner peripheral side thereof in such a manner as to cover it from above.

On the lower face side of the body 100a, an inserting groove 100c of the shape of a long hole similar in shape to a deep hole 55 formed in the flow path plate 50 is formed like a gutter. A retaining member, not shown in the diagram, made of stainless steel, for example, is removably attached to the inserting groove 100c and this retaining member is used to retain the gasket 140 on the lower face side of the body 100a. The gasket 140 has the bottom face thereof protrude from the retaining member, and this protruding portion is disposed so that it may be inserted in the deep hole 55.

When the integration unit 100 is attached to the flow path plate 50, by keeping the retaining tubular member 111 mounted on the flow path plate 50 and causing the gasket 140 to be nipped between the inserting groove 100c of the integration unit 100 and the deep hole 55 of the flow path plate 50 by the use of the retaining member, the integration unit 100 is enabled to be supported in a positioned state. Subsequently, by causing the union nut 120 to be squeezed into the retaining tubular member 111, the female screw part 121 of the union nut 120 and the male screw part 114 of the retaining tubular member 111 are brought into helical union and the integrating nit 100 is fixed to the flow path plate 50. When the integration unit 100 is moved downwardly in the bearing of FIG. 7 in consequence of the squeezing of the union nut 120, the bottom face side of the body 100a eventually comes and depresses the flow path plate 50 while the gasket 140, etc. seal the interval between the inserting groove 100c and the deep hole 55 in the manner of applying pressure. Consequently, the retaining tubular member 111 moves upwardly and presses the hook parts 112 and the flange parts 57 of the flow path plate 50 against each other and consequently fixes the retaining tubular member 111 in position. As a result, the integration unit 100 is retained in the state of being connected to the flow path plate 50. Then, after the union nut 120 has been tightened, the seal member 146 is interposed between the annular radially converged part 122 and the upper face side of the retaining tubular member 111 and consequently enabled to keep them closely sealed.

The work of tightening the union nut 120 mentioned above is carried out with a tightening tool not shown in the diagram by the procedure which comprises fitting the nut part 123 of the union nut 120 in the nut part formed on the inner face side of the tightening tool and manually tightening the union nut 120 rather strongly till the gasket 140, etc. is brought into close contact with the deep hole 55 which constitutes the sealing surface with the gasket 140. Subsequently, by turning the handle provided on the tightening tool farther by an angle of about 90 degrees from the ensuing state, the gasket 140 is depressed and the integration unit 100, the entrance flow path 67 and the exit flow path 68 are brought into a sealed state infallibly.

When the integration unit 100 is set by center lock means using the retaining tubular member 111 and the union nut 120 as described above, the integration unit 100 has no possibility of inclining from the positioned state relative to the flow path plate 50 and consequently has no possibility of being unevenly clamped and is enabled to maintain a tightly sealed state. Particularly since the integration unit 100 is helically fixed and connected by using the union nut 120, it is made possible to tighten the whole of the integration unit 100 in good balance by a simple operation without generating couple of force and improve the sealing property. Further, the fitting part is prevented from gaining in volume and can be miniaturized. As regards the fitting structure of the integration unit 100, besides the fixation attained by the center lock means using the retaining tubular member 111 and the union nut 120 or the welding of the retaining tubular member 110, the integration unit may be fixed to the flow path plate by tightening the integration unit from above with four bolts. The fitting can be attained by any of various other mounting structures.

The individual integration unit 100, after being connected to the flow path plate 50, is nipped by the intermediate flow path plate and the trailing terminal flow path plate not shown in the diagram and then is enabled, in the ensuing state, to be positioned and fixed in the state of being guided by the flange parts 57 and 57 in the direction of the flow path by helically fixing the bolts not shown in the diagram to the female screws formed respectively in the intermediate flow path plate and the trailing terminal flow path plate. Consequently, the integration units 100 corresponding to an entrance flow path 67 and an exit flow path 68 for the gas formed in the flow path plate 50 are maintained in the state of being connected to the second gas flow path and the first gas flow path.

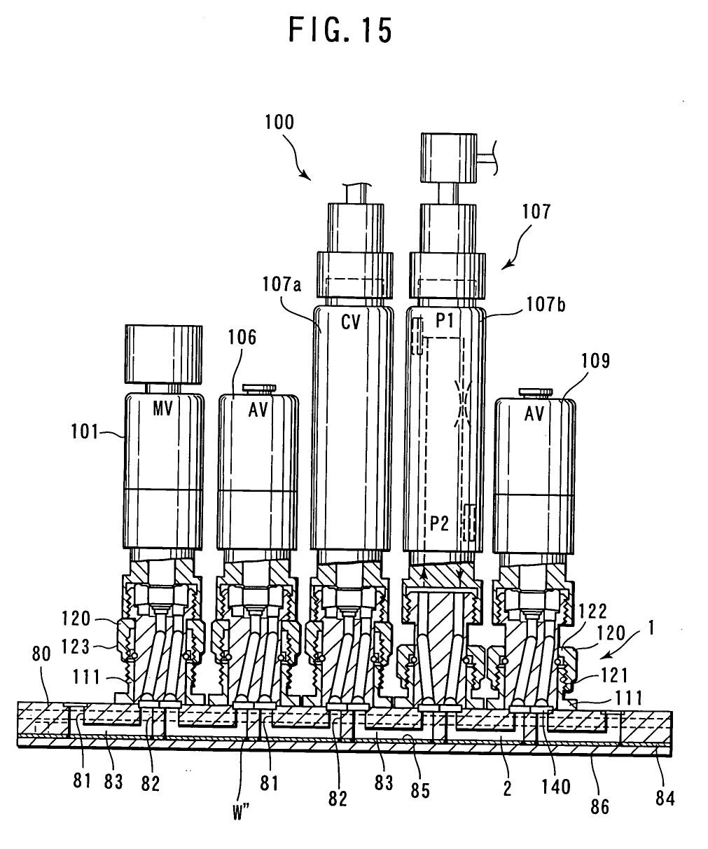

FIG. 15 illustrates the third embodiment of the integrated gas control device contemplated by this invention. A flow path plate 80 is a flow path plate provided in the interior thereof with a gas flow path 83 and a seal plate 84 is a plate for covering at least substantially the whole surface of an opening groove part 85 side formed in the flow path plate 80. By fixing this seal plate 84, a gangway 81 on the entrance side and a gangway 82 on the exit side and the opening groove part 85 are closely sealed and further a reinforcing plate 86 is superposed on the seal plate 84 and consequently enabled to reinforce it. The flow path plate 80 and the seal plate 84 are fixed in a closely sealed state at the welding point W″ by means of welding, such as electronic beam welding, laser welding or spot welding. This welding is carried out in such a manner as to give rise to a circumferential contact portion between the opening groove part 85 and the seal plate 84 and is completed in a short span of time by forming the gangways 81 and the opening groove part 85 in a platy material by a continuous boring work as computer-controlled with a control processing machine and subsequently continuing the welding. Further, the reinforcing plate 86 is fixed to the seal plate 84 for integration by the same welding means or by some other fixing means and the seal plate 84 is reinforced after welding by the reinforcing plate 86. A proper substance, such as aluminum, may be used as the material for the reinforcing plate 86.

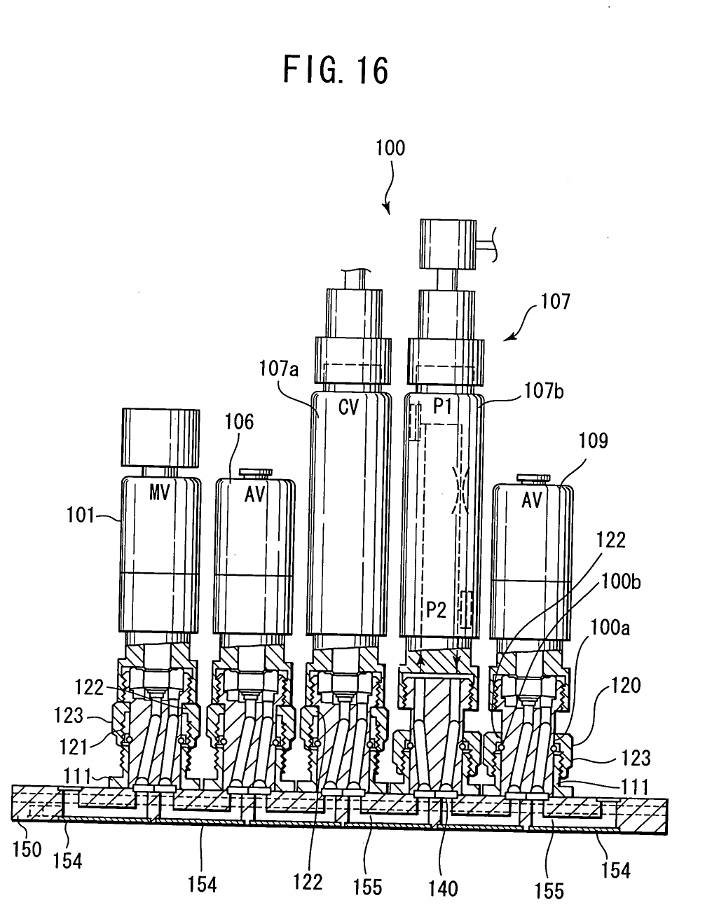

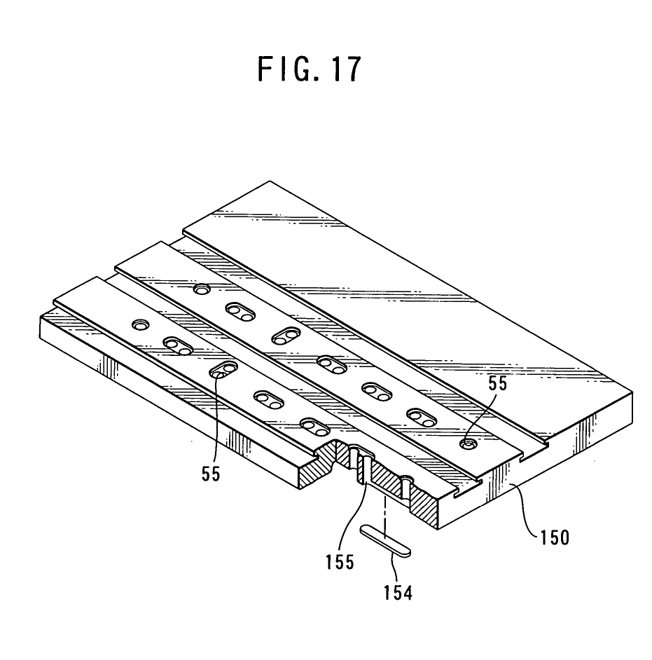

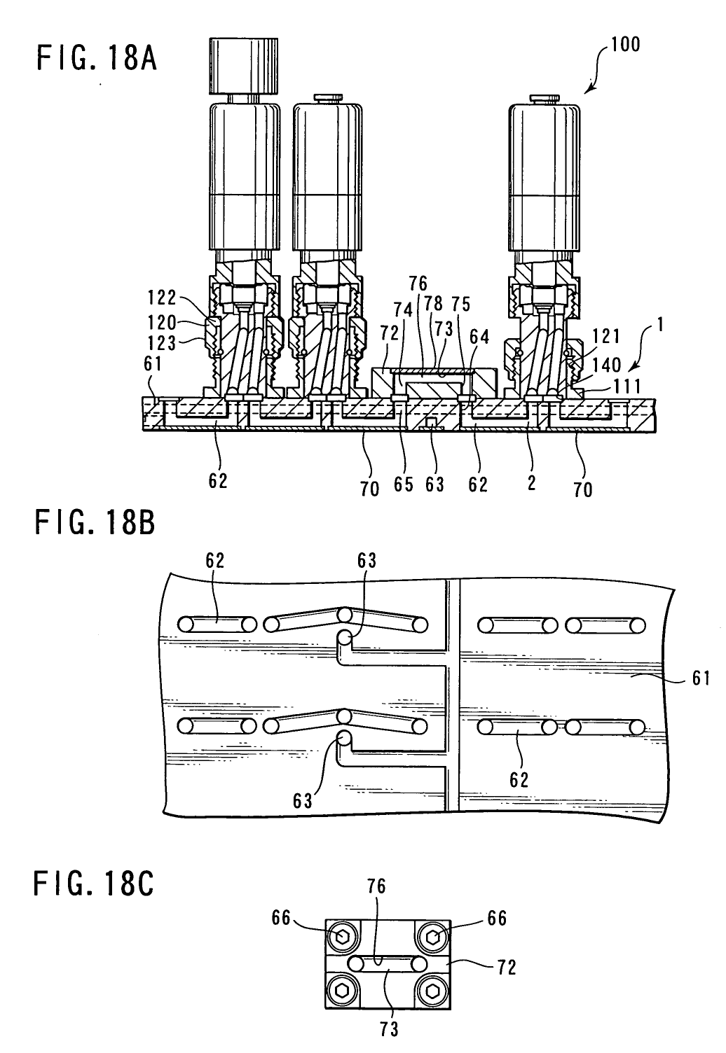

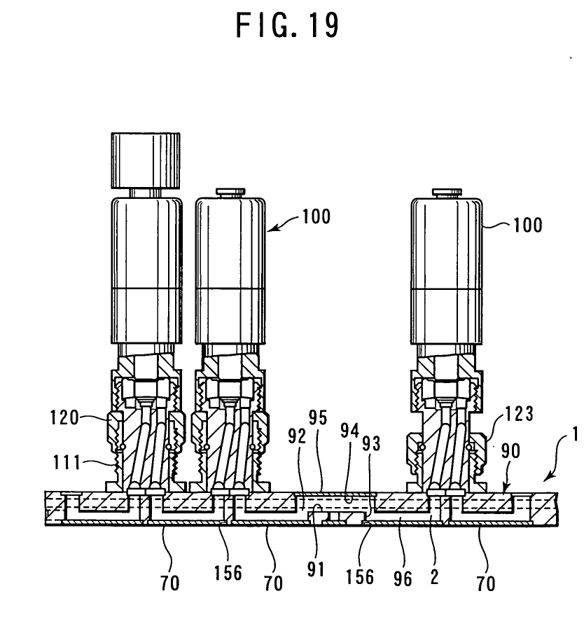

FIG. 16 and FIG. 17 illustrate the fourth embodiment of the integrated gas control device contemplated by this invention. It is so configured as to seal closely an opening groove part 155 formed in a flow path plate 150 with a seal plate 154 and fix the integration unit 100 with a center lock mounting means using a retaining tubular body 111 and a union nut 120. FIGS. 18 and 19 illustrate an integrated gas control device that has a bypass formed halfway in the length of the gas controlling line. In the case of a configuration having a purging flow path 63 intersect a gas flow path 62 of a flow path plate 61 as illustrated in FIG. 18B, it is enabled to provide a gas controlling line adapted to detour the purging flow path 63 by causing a flow path plate 72 furnished in the interior thereof with a bypass flow path 73 to be fixed with a fixing bolt 66 so as to establish connection between an exit flow path 65 and an entrance flow path 64 of the flow path plate 61. Thus, the gas controlling line is allowed to have a structure capable of intersecting the purging flow path 63 with the gas flow path 62. It is further permissible to impart to the gas controlling line such a structure as to enable the direction of flow path to be altered in consequence of the change of the mounting position of the integrated gas control device and facilitate the construction of flow paths as well. The work of processing the bypass flow path 73 can be carried out similarly to the work of processing the flow paths of the flow path plate by the procedure which comprises first boring entrance and exit through holes along the direction of wall thickness and give rise to gangways 74 and 75, then forming an opening groove part 76 adapted to connect the gangways 74 and 75 on one face side, and closely sealing the opening groove part 76 with a seal plate 70 and consequently giving rise to the bypass flow path 73. The work of fixing a seal plate 78 to the opening groove part 76 may be implemented by the use of a welding means, such as electron beam welding.

The bypass flow path may be otherwise formed in such a shape as illustrated in FIG. 19. This bypass flow path 91 is formed in the direction intersecting the gas flow path without using the flow path plate by the procedure which comprises first forming gangways 92 and 93, then causing an opening groove part 94 serving to connect these gangways 92 and 93 to open in the face opposite an opening groove part 156 of a gas flow path 96, and fixing a seal plate 95, and fixing a seal plate 95 to the opening groove part 94 and concealing this groove part 94.

The above embodiment has the flow path plate 90, the seal plate 70 and the seal plate 95 forming the bypass flow path 9 invariably formed of stainless steel as a material. Nevertheless, these components may be formed of any of metallic materials other than stainless steel. They may be even formed of a material, such as resin that possesses resistance to corrosion.

1. An integrated gas control device comprising:
a flow path plate provided with entrance and exit holes penetrating the flow path plate in a direction of wall thickness thereof to form entrance side gangways and exit side gangways, opening groove parts opened in one or both of opposite face sides of the flow path plate and adapted to connect the entrance side and exist side gangways, seal plates for closely sealing the opening groove parts to form gas flow paths in the flow path plate; and
integration units, including automatic valves, each having a flow path that are so mounted on the flow path plate as to connect the flow path to the entrance and exit holes of the flow path plate and so disposed as to allow supply of a gas including a process gas.

2. An integrated gas control device according to claim 1, wherein the seal plates each have a size proper for completely covering the opening groove parts.

3. An integrated gas control device according to claim 1, wherein the seal plates cover at least a substantially whole surface of the flow path plate on a side of the opening groove parts, and the opening groove parts are closely sealed through fixation of the seal plates thereon.

4. An integrated gas control device according to claim 3, wherein the seal plates are reinforced each with a reinforcing plate superposed thereon.

5. An integrated gas control device according to claim 1, wherein the seal plates closely seal and fix the flow path plate by means of welding that is electron beam welding, laser welding, TIG welding or brazing.

6. An integrated gas control device according to claim 2, wherein the seal plates closely seal and fix the flow path plate by means of welding that is electron beam welding, laser welding, TIG welding or brazing.

7. An integrated gas control device according to claim 1, wherein the seal plates closely seal and fix the flow path plate by means of welding that is electron beam welding, laser welding or spot welding.

8. An integrated gas control device according to claim 3, wherein the seal plates closely seal and fix the flow path plate by means of welding that is electron beam welding, laser welding or spot welding.

9. An integrated gas control device according to claims 4, wherein the seal plates closely seal and fix the flow path plate by means of welding that is electron beam welding, laser welding or spot welding.

10. An integrated gas control device according to claim 1, wherein the gas flow paths comprise first flow paths directed toward the gangways and the opening groove parts and second flow paths assuming directions different from the first flow paths.

11. An integrated gas control device according to claim 1, further comprising circular mounting parts formed on a side of the flow path plate for mounting the integration units thereon, retaining tubular members formed substantially in a cylindrical shape and inserted into the circular mounting parts, and wherein the integration units are fixed onto the flow path plate through the retaining tubular members.

12. An integrated gas control device according to claim 11, further comprising mounting parts insertable in the flow path plate and formed in lower parts of the retaining tubular members, cylindrical mounting tubes disposed on an upper face side of the mounting parts, helically attachable union nuts provided on the mounting tubes, and center lock means clamping the union nuts on the retaining tubular members and fastening the integration units to the flow path plate while the retaining tubular members are kept inserted in the flow path plate.

13. An integrated gas control device according to claim 12, further comprising one set of flange parts formed protrudingly on a side of the flow path plate for mounting the integration units thereon and idly insertable hook members formed on opposite sides of the mounting parts as slid in a direction of the flow paths toward the flange parts, the hook members being idly inserted into the flange parts so as to insert the retaining tubular members into the flow path plate.

14. An integrated gas control device according to claims 3, wherein the gas flow paths of the flow path plate are formed as disposed in a multiplicity of rows and further comprising purging flow paths formed in a collected pattern for expelling gas from interiors of the individual gas flow paths.

15. An integrated gas control device according to claim 3, further comprising deep holes formed in the flow path plate, inserting grooves identical in shape with the deep holes formed on a lower face side of a body of each of the integration units, and gaskets retained between the flow path plate and the body.

16. An integrated gas control device according to claim 1, further comprising a purging flow path formed in the flow path plate to intersect the flow paths for purging the gas in the flow paths and a bypass flow path formed halfway in lengths of gas flow paths for detouring the purging flow path.
